(19) United States
(12) Patent Application Publication
(10) Pub. No.: US 2018/0376569 A1
(43) Pub. Date: Dec. 27, 2018

(54) KEYWAY ILLUMINATION SYSTEM

(71) Applicant: Nipong Vang, Wrightsville, PA (US)

(72) Inventor: Nipong Vang, Wrightsville, PA (US)

(21) Appl. No.: 15/631,891

(22) Filed: Jun. 23, 2017

(51) Int. Cl. H05B 37/02; F21L 4/08; E05B 17/10; E05B 19/04

(52) U.S. Cl. CPC H05B 37/0272; F21L 4/08; F21Y 2115/10; E05B 17/103; E05B 19/04; H05B 37/0281

(57) ABSTRACT

The present invention relates generally to a keyway illumination system with a rack to recharge the device. More so, the present invention relates to a system that enables a keyway to be illuminated when a corresponding key approaches the known WIFI connected through a mobile app from a predetermined distance, so as to enhance viewing the engagement between key and keyway.

### FIELD OF THE INVENTION

The present invention relates generally to a keyway illumination system. More so, the present invention relates to a system that enables a keyway to be illuminated when a corresponding key approaches the known WIFI from a predetermined distance, so as to enhance viewing the engagement between key and keyway; whereby the key is adapted to mate with a smart key case that provides both the gripping surface necessary to apply torque to the key, and the electrical communication components necessary to actuate illumination of the keyway and communicates with the smart key case to emit a steady beam of light directly onto the keyway when detecting proximal illumination from the smart key case. The keyway illumination system is equipped with a wireless key charger rack to charge until battery for the key is fully charged, indicating when to stop the charging.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is known that a key is a device that is used to operate a lock (such as to lock or unlock it). A typical key is a small piece of metal consisting of two parts: the blade, which slides into the keyway of the lock and distinguishes between different keys, and the bow, which is left protruding so that torque can be applied by the user. The key serves as a security token for access to the locked area; only persons having the correct key can open the lock and gain access.

Door lock keys are devices that allow security access to its user. However, the inexpensive device can become difficult to use in locations with poor lighting, owing to weather conditions, time of day or physical orientation of the lock. To address this problem, illumination is the required solution. There are night light devices that illuminate around the keyway in conditions that ordinarily make the key's usage difficult.

There is a need for a keyhole-illuminating device that provides easy access and high visibility in the dark, while requiring minimal energy expenditure. There is also a need for a reliable device that illuminates the keyway as the matching key is engaging the keyway, but powers off when the key have completed the locking or unlocking operation.

Other proposals have involved illuminating keyways and doors. The problem with these illumination devices is that they do not power on and off at the right time. Also, they do not indicate if the matching key is being used in the keyway. Even though the above cited illuminating devices meets some of the needs of the market, a keyway illumination system that is adapted to operate with a variety of keys having different sizes and types, and enables a keyway to be illuminated when a corresponding key approaches the keyway at a predetermined distance, so as to enhance visibility of the engagement point between the key and the keyway, and also allows for verification that the key is engaging the correct matching keyway through a unique color matching function, is still desired.

### SUMMARY

Illustrative embodiments of the disclosure are generally directed to a keyway illumination system. The system selectively illuminates a keyway that matches the key when the key is detected at a predetermined, WIFI proximal distance. The system also provides visual verification that the key is engaging the correct matching keyway through a unique function that matches LED colors, intensities, or patterns between a smart key case coupled to the key.

In some embodiments, the system provides a smart key case. The smart key case is configured to receive, securely fasten, and release a key. The smart key case receives and fastens the key with the blade exposed for operation with a keyway. The key may include a standard key known in the art having a blade, which slides into the keyway of a lock and distinguishes between different keys; and the bow, which is left protruding so that torque can be applied to rotate the key in the keyway. The smart key case in essence, replaces the bow of the key. The smart key case provides the gripping surface necessary to apply torque to the key.

Furthermore, the smart key case provides the electrical and lighting communication components necessary to actuate illumination of the keyway. The smart key case has various illumination components, operational switches, and a receiver that enable communications for activating and deactivating illumination on the keyway, chiefly dependent on the WIFI proximity and illuminating status of the smart key case to the keyway. When user enter the proximity with LED Smart Key, the illumination has a set timer that powers off the illumination after entering.

In one embodiment, the smart key case detachably couples to a key. The smart key case orients the key in a natural position for operation of the key through a keyway. The smart key case comprises a housing configured to detachably couple to one end of a blade of the key. In this manner, torque can be applied to the key in a keyway.

The smart key case further comprises a key illumination device configured to illuminate. The illumination from the key illumination device may include a light emitting diode that selectively emits customized colors.

The smart key case further comprises a key power source, such as a coin battery. A power source enclosure is configured to retain the key power source.

In the sequence of procedures, the user would approach the keyway with the smart key. The WIFI automatically connects to the key through and an app and consequently activates the light, which enhances visibility of the keyway.

In one aspect, a keyway illumination system comprises:

a key defined by a blade, the blade configured to enable accessibility;
a smart key case comprising:
a housing configured to detachably couple to the key, the housing further configured to enable application of torque on the key,
a key illumination device configured to illuminate,
a receiver configured to enable wireless communication;
whereby the light is activated when WIFI automatically connects from the key illumination device,
whereby the light is deactivated when the illumination from the key illumination device is deactivated,
a wireless communication system configured to transmit a signal to the App,

In another aspect, the blade of the key is configured to enable accessibility to a keyway.

In another aspect, the key is a vehicle key.

In another aspect, the housing of the smart key case is configured to receive one end of the blade.

In another aspect, the key illumination device is a light emitting diode.

In another aspect, the illumination from the key illumination device comprises customized colors.

In another aspect, the smart key case further comprises a case printed circuit board.

In another aspect, the smart key case further comprises a key power source.

In another aspect, the key power source comprises a coin battery.

In another aspect, the smart key case further comprises power source enclosure configured to retain the key power source.

In another aspect, when user enters the proximity with LED Smart Key, the illumination has a set timer that powers off the illumination after entering.

In another aspect, the illumination from the module illumination device comprises customized colors.

In another aspect, the wireless communication system is configured to operate with WIFI.

One objective of the present invention is to illuminate a dark area near a keyway of a vehicle as the key moves proximally to the keyway.

Another objective is to verify that the key is engaging a matching keyway.

Another objective is to provide a smart key case that supplements the bow of a key to enable turning the key in the keyway.

Yet another objective is to indicate through Bluetooth and WIFI communication and matching LED lights on the smart key case, the matching key for the keyway.

Yet another objective is to provide an inexpensive, easily accessible power source for the smart key case.

Yet another objective is to display a vehicle brand name on the housing of the smart key case.

In another aspect, The keyway illumination system is equipped with a wireless key charger rack to charge until battery for the key is fully charged, indicating when to stop the charging.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary keyway illumination system, highlighting the internal components, showing a smart key case, a key, in accordance with an embodiment of the present invention;

FIG. 2 illustrates an elevated front and side view illuminated and non-illuminated of a smart key, in accordance with an embodiment of the present invention;

FIG. 3 illustrates wireless key charger rack, in accordance with an embodiment of the present invention;

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

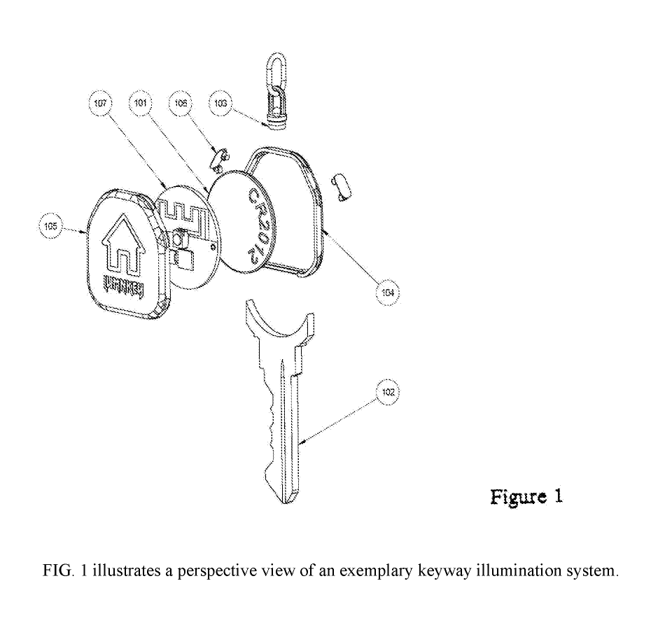

A keyway illumination system is referenced in FIGS. 1-3. The keyway illumination system operable with different types, models, and purposes of keys. System illuminates a keyway that matches the key when key is detected through WIFI at a predetermined, proximal distance from keyway. System also provides visual verification that key is engaging the correct matching keyway through a unique function that matches LED colors, intensities, or patterns between a smart key case coupled to the key. The keyway illumination system is also equipped with a wireless key charger rack to charge until battery for the key is fully charged, indicating when to stop the charging.

As referenced in FIG. 1, system may be adapted to operate with a variety of keys having different sizes and types. Those skilled in the art will recognize that a key is a tool that is used to operate a lock, such as to lock or unlock it. The key, as used here may open various objects, including, without limitation, a vehicle door, a building door, a display, a box, a luggage, a safe, and a window.

System enables a keyway to be illuminated when the corresponding key approaches the WIFI at a predetermined distance. This selective lighting allows for enhanced visibility of an engagement point between the key and the keyway. This type of lighting may be especially useful at night or in dark areas where visibility is limited. System also allows for verification that the key is engaging the correct matching keyway through a unique LED color matching function. This can be useful when multiple objects having keyways are clustered together and it is not certain which keyway the key fits.

As illustrated in FIG. 1, system comprises a smart key case that detachably couples to key 104 and 105 to provide a gripping surface for applying torque to the key when engaging the keyway. Smart key case 104 and 105 orients the key in a natural position for operation of the key through a keyway. Smart key case also serves to contain and enable control of electrical components that selectively illuminate and communicate to actuate illumination of the keyway.

As illustrated in FIG. 1, smart key case comprises a key illumination device configured to selectively illuminate based on an event. In one embodiment, the illumination from key illumination device is generated from a light emitting diode that emits customized colors. In another embodiment, key illumination device is a five millimeter LED that provides efficient illumination with a very low consumption of battery life.

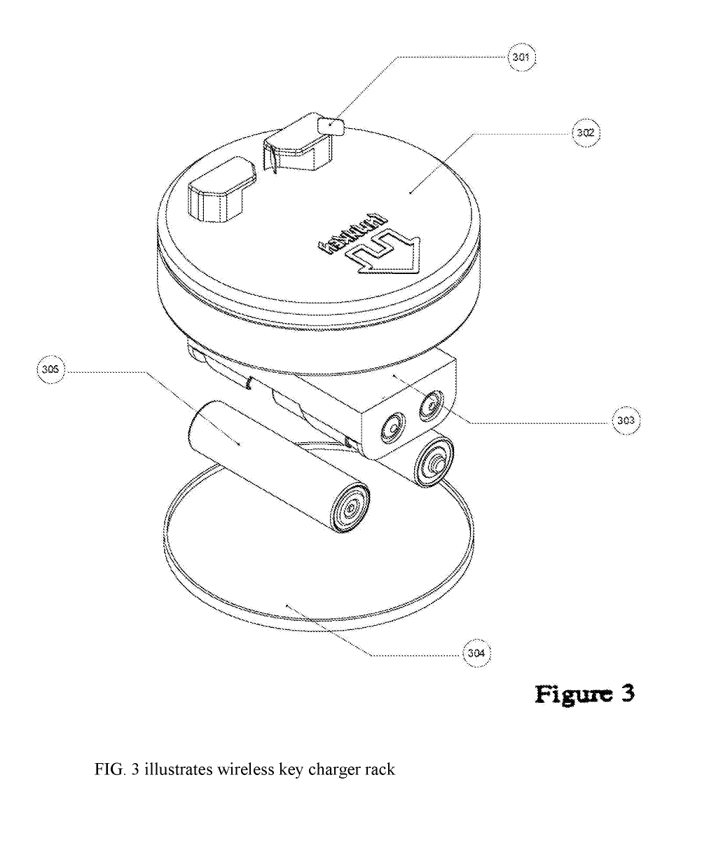

As illustrated in FIG. 3, the rack assembly consists of front body 302 and back cover 304 to protect the casing and interior. There are metal plates 301 on the outer covering 302. Then there is a battery holder 303 consisting of batteries 305 to charge the battery of the key.

In one embodiment, when the user enters the proximity with LED Smart Key, the illumination has a set timer that powers off the illumination after entering. The preset timer automatically turns off once the user enters through the keyway using the key.

Smart key case further comprises a key power source, such as a coin battery 101. In one embodiment, key power source 101 is a coin shaped cell (2032), or a small three-volt disposable lithium cell that serves as a power source for the electronic components in the smart key case. A power source enclosure is configured to retain the key power source.

Smart key case may contain a power source enclosure having positive and negative terminals to enhance conduction of the key power source. Key power source slides into such a power source enclosure. Though in other embodiments, any battery enclosure known in the art may be used.

In one sequence of procedure, the user would approach the keyway with the smart key, case. The key on approaching the WIFI proximity automatically connects with already registered app and consequently activates the light, which enhances visibility of the keyway.

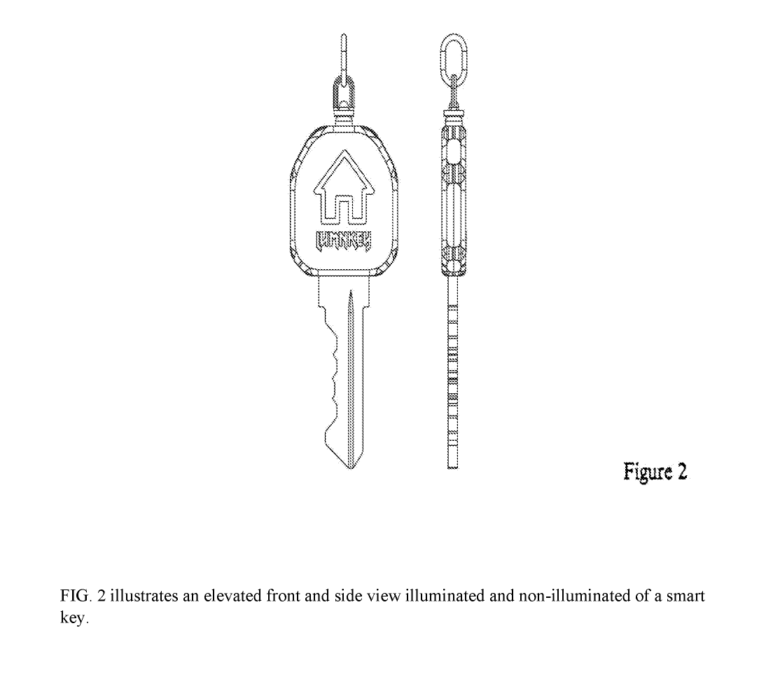

Now turning to FIG. 2 It shows the front side views of the key when non-illuminated and when illuminated.

All parts listed are classified based on their market availability, where they are identified as commercial off the shelf (COTS) parts. Production requires assembly of all parts and the Outer coverings. These have to be essentially manufactured according to their dimensions and specifications.

Manufacturing variation by design is limited to the Outer coverings. Variations are governed by the dimensions of the underlying parts of the device. These variations shall however inherit the principal purpose. Other variations may exist based on style.

The smart key case design principle is to accommodate any patented key conveniently.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

1) A keyway illumination system, the system comprising:
a key defined by a blade, the blade configured to enable accessibility;
a smart key that connects to WIFI automatically through a mobile app once the users enters the proximity;
an LED Smart Key in which the illumination has a set timer that powers off the illumination after entering.

2) A smart key case having:
a housing configured to detachably couple to the key, the housing further configured to enable application of torque on the key;
a single cell 2032 battery to give power;
a key use to unlock the door;
a key ring holder;
a key illumination device configured to illuminate;
a receiver configured to enable wireless communication.

3) The system of claim 2, wherein the housing of the smart key case is configured to receive one end of the blade through a slot. The system of claim 2, further comprising a locking mechanism configured to fasten and unfasten the key and the housing. The system of claim 2, wherein the housing comprises a plurality of fasteners.

4) The system of claim 2, wherein the illumination from the key illumination device comprises customised colors. The system of claim 2, wherein the smart key case further comprises a case printed circuit board.

5) The system of claim 2, wherein the smart key case further comprises a key power source. The system of claim 2, wherein the key power source comprises a coin battery. The system of claim 2, wherein the smart key case further comprises power source enclosure configured to retain the key power source.

6) Wireless key charger rack comprising:
front and back body casing having metal plates;
battery holder;
chargeable batteries.
